(19) United States
(12) Patent Application Publication
(10) Pub. No.: US 2004/0267796 A1
(43) Pub. Date: Dec. 30, 2004

(54) Data exchanger apparatus, data exchange method and program therefore

(76) Inventor: Yumiko Shimogori, Kawasaki-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/830,239

(22) Filed: Apr. 23, 2004

(30) Foreign Application Priority Data
Apr. 25, 2003 (JP) 2003-122341

(51) Int. Cl. G06F 17/00

(52) U.S. Cl. 707/101

(57) ABSTRACT

A data exchanger apparatus comprises a first memory unit storing first data concerning hierarchical structures, and second data concerning attributes of classification items that are configured with the hierarchical structures, respectively, with being associated in hierarchy therewith, each of the classification items having attributes including an attribute of an upper hierarchical classification item of the classification items, a second memory unit storing contents data belonging to the classification items, respectively, and containing attribute values of the attributes of the classification items, a data generator generating transmission data including text data and an identifier and version information of each hierarchical structure, the text data including the attribute values delimited by a first delimiter code and the contents data delimited by a second delimiter code, and a data transmitter to transmit the transmission data.

### CROSS-REFERENCE TO RELATED APPLICATIONS

This application is based upon and claims the benefit of priority from prior Japanese Patent Application No. 2003-122341, filed Apr. 25, 2003, the entire contents of which are incorporated herein by reference.

### BACKGROUND OF THE INVENTION

1. Field of the Invention

The present invention relates to a data exchanger and a data exchanger apparatus.

2. Description of the Related Art

There is ISO 13584 (Parts Library) as International Standard to implement an electronic catalog system providing product information on Internet electronically. ISO 13584 aims at sharing and reusing product information by comprising an electronic catalog with schema and contents that are standardized in data structure. In the schema defining in ISO 13584, the product classification expresses “classes” hierarchically in a single tree structure. The “product classes” have “properties (attributes)” respectively. The subclasses inherit properties of upper classes. The “class” and “property” are attached with unique IDs called “BSU code” making it possible to be uniquely specified.

On the other hand, a part of contents is expressed as a table wherein attribute values inherent to the products are embedded in properties defined by this schema. ISO 13584 provides a framework as an electronic catalog.

In addition, international standardization on actual schema is gone forward, too. IEC 61360 promotes standardization for an upper hierarchy part of schema in the field of electricity/electron, that is, a general part on “class” and “property.” As a result, product catalog creators of each company can decide original detail “class” and “property” for a lower development from IEC 61360, and create respective contents.

A user of the electronic catalog traces such contents along a classification hierarchy of “classes”, and narrow down the product which is necessary for the user referring to the attribute value to make it possible to search a desired product.

In late years, some systems based on ISO 13584 will be developed. According to a method of dividing a schema based on 13584 ISO into part sets and exchanging them, an identifier of the division file which is necessary to restore it is provided as complementary data when the part sets are generated (for example, Japanese Patent Publication No. 2001-147920).

Simple Object Access Protocol (SOAP) is a protocol of an XML base for exchanging information structured between systems in non-intensive/distributed circumference summarizing a specification in W3C and then shaped. SOAP defines a simple mechanism for expressing semantics of an application by providing a packaging model of a module type for encoding data as a module and an encoding mechanism.

There is a method to use CSV (Comma Separated Value) for the purpose of compressing an XML document. This classifies the XML document in a to-be-processed object and a non-processed object, and compresses the XML document by converting parts of the non-processed object into a CSV format. In ISO 13584, the schema becomes a model changeable as meta data.

Contents have description separable from the schema by identifying corresponding schema. However, actually, data exchange between the schema and contents is done by one format at the same time.

There is a method of describing in an XML format to exchange data with separating the schema and contents. XML is suitable for classification having a structure and description of attribute. However, when enormous volume of contents are exchanged, there are such problems that it takes a long time to generate data and a communication cost increases due to increase of amount of data to be exchanged.

On the other hand, most information of the contents can be described in table format. The table format is popularized expression method, but can suppress description efficiency to around one-third in comparison with the case where the same information is described in XML. However, the table format is short in description capability. Therefore, it is not effective for a data exchange format in a B2B business of late years.

Japanese Patent Publication No. 2001-147920 describes to permit data exchange of necessary amount of data by dividing the schema, but do not mention on improvement of efficiency of a format to carry out data exchange particularly. SOAP is a specification on a protocol of data exchange based on XML, but does not define meaning of a format of data to be transmitted.

A method of CSV-compressing a XML document CSV-compresses a non-processed object part, but cannot compress a to-be-processed object part. This technique is based on the XML document, and must describe data acquired from a database by an XML format once.

As described above, when a conventional apparatus transfers (exchanges) enormous amount of contents data arranged in hierarchical structure to other apparatuses, it has to generate integrated transmission data without completely separating the contents data and the hierarchical structure to send both of schema expressing a hierarchical structure and contents data or contents data in an XML format. For the reasons, there is a problem to be unable to easily shorten a processing time for generating transmission data and a transmission time.

An object of the present invention is to provide a data exchange method that can effectively generate and transmit transmission data by reducing an amount of transmission data.

### BRIEF SUMMARY OF THE INVENTION

An aspect of the present invention provides a data exchanger apparatus comprising: a first memory unit configured to store first data concerning a plurality of hierarchical structures, and second data concerning a plurality of attributes of a plurality of classification items that are configured with the hierarchical structures, respectively, with being associated in hierarchy therewith, each of the classification items having attributes including an attribute of an upper hierarchical classification item of the classification items; a second memory unit configured to store a plurality of contents data belonging to the classification items, respectively, and containing attribute values of the attributes of the classification items; a data generator to generate transmission data, the transmission data including text data, an identifier of each of the hierarchical structures and version information thereof, and the text data including the attribute values delimited by a first delimiter code and the contents data (set of attribute values) delimited by a second delimiter code; and a data transmitter to transmit the transmission data.

Another aspect of the invention provides a data exchanging method comprising: preparing a database to store contents data having a plurality of hierarchical structures associated in hierarchy with a plurality of classification items each having attributes including an attribute of an upper hierarchical classification item of the hierarchical classification items, the contents data configured with attribute values of the attributes of each of the classification items; reading a plurality of contents data registered with the classification item of one hierarchical structure of the hierarchical structures; generating transmission data including text data and an identifier and version information of each of the hierarchical structures, the text data including the attribute values delimited by a first delimiter and the contents data delimited by a second delimiter; and transmitting the transmission data.

### BRIEF DESCRIPTION OF THE SEVERAL VIEWS OF THE DRAWING

FIG. 1 is a schematic diagram of a data exchange unit according to an embodiment of the present invention.

FIG. 2 is a schematic diagram of a hierarchical structure of a hierarchical database.

FIG. 3 is a diagram showing a hierarchical structure of a hierarchical database.

FIG. 4 is a diagram showing a data storage example of data regarding classification items within schema data stored in a schema memory.

FIG. 5 is a diagram showing a data storage example of data regarding attribute within schema data stored in a schema memory.

FIG. 6 is a diagram showing a storage example of a classification identifier of each schema and version information within schema data stored in a schema memory.

FIG. 7 is a diagram showing a storage example of contents data stored in a contents memory.

FIG. 8 is a diagram showing a storage example of contents data stored in a contents memory.

FIG. 9 is a diagram showing a storage example of contents data stored in a contents memory.

FIG. 10 is a schematic diagram illustrating an updated hierarchical structure of a hierarchical database.

FIG. 11 is a diagram showing an updated hierarchical structure of a hierarchical database.

FIG. 12 is a process flowchart to explain a processing operation of a data exchanger unit.

FIG. 13 is a diagram showing an example of contents data provided as search results in a data exchanger unit.

FIG. 14 is a flowchart to explain a data retrieval process operation.

FIG. 15 is a flowchart to explain a transmission data generation process operation.

FIG. 16 is a diagram showing an example of the first transmission data.

FIG. 17 is a diagram showing another example of the first transmission data.

FIG. 18 is a flowchart to explain a data transfer process operation.

FIG. 19 is a flowchart to explain a data reception process operation.

FIG. 20 is a diagram showing an example of the second transmission data.

FIG. 21 is a flowchart to explain a receive data registration process operation.

FIG. 22 is a diagram showing an example of a command made in a receive data registration unit.

FIG. 23 is a flowchart showing another example if the transmission data generation process operation.

FIG. 24 is a diagram showing a further another examples of the first transmission data.

### DETAILED DESCRIPTION OF THE INVENTION

There will now be explained an embodiment of the present invention referring to drawing.

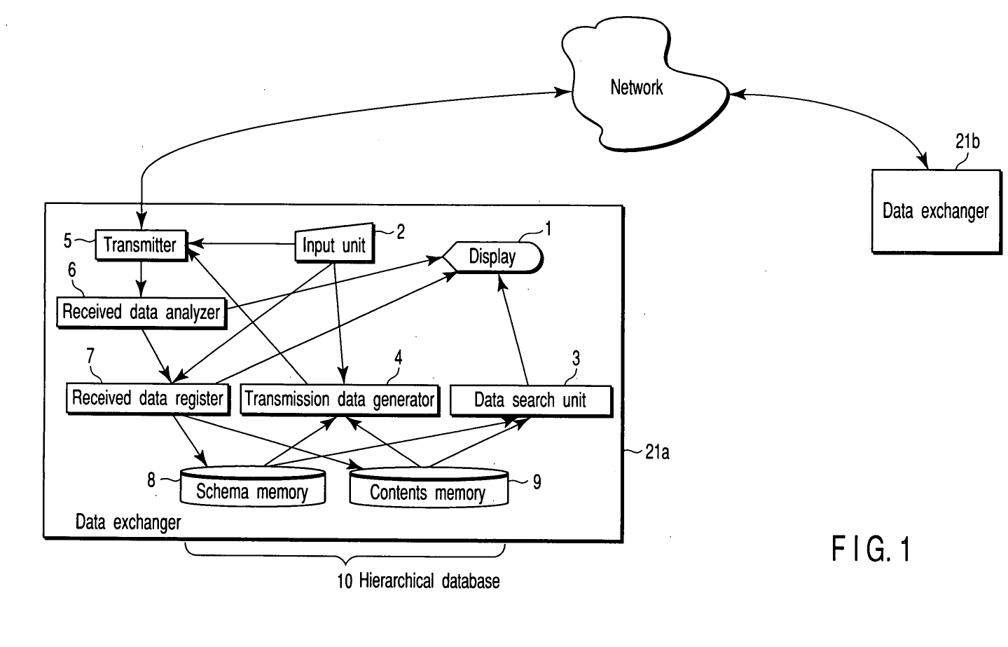

FIG. 1 shows a configuration of a data exchanger concerning an embodiment of the present invention and a configuration of a system for exchanging data by means of a plurality of data exchangers. In other words, according to FIG. 1, data is exchanged between a plurality of data exchangers, for example, two data exchangers 21a and 21b which are the same configuration.

An example to transmission data from the data exchanger 21a and receive the transmission data with the data exchanger 21b will be described. At first, the configuration of the data exchanger 21a is described hereinafter.

In FIG. 1, the data exchanger 21a comprises a display unit 1, an input unit 2, a data search unit 3, a transmission data generator 4, a communications unit 5, a received data analyzer 6, a received data register 7, and a hierarchical database 10 including a schema memory 8 and a contents memory 9. The data exchangers 21a and 21b can be connected to each other through a network of Internet, for example, to communicate with each other.

The hierarchical database 10 has a structure that a route node is connected to a plurality of hierarchical structures which are associated in hierarchy with a plurality of classification items. Each classification item configuring each of several hierarchical structures has an attribute including an attribute of a classification item of a higher hierarchical layer of the classification item. The contents data having the same attribute as that of the classification item is registered with each classification item. A classification item configuring each of the several hierarchical structures, a membership between the classification items, and information on each hierarchical structure of the attribute of each classification item, i.e., schema data are stored in the schema memory 8. The contents data having the same attribute as that of each classification item is stored in the contents memory 9 in association with the classification item stored in the schema memory 8.

The contents data configured with values corresponding to a plurality of attributes stored in the contents memory 9 is referred to as record data. Several hierarchical structures (schema data) are stored in the schema memory 8 as described above, but an identifier (schema identifier) to identify each hierarchical structure is given to each hierarchical structure. Each hierarchical structure (schema data) is updated at any time. Consequently, each hierarchical structure uniquely is specified along with the identifier and version information (assumed by, for example, combination of the version number (version) and the revision number (revision)).

A plurality of classification items stored in the schema memory 8, a membership between the classification items, an attribute or the like are prescribed ones such as classification items based on 13584 ISO or attributes. The contents data stored in the contents memory 9 are the prescribed classification items and attributes. The classification item and attribute have identifiers to identify the classification item and attribute, respectively, beforehand (BSU code which is defined by, for example, ISO 13584).

The data exchangers 21a and 21b are assumed to identify the hierarchical structure, classification item and attribute with an identifier to identify the hierarchical structure and version information, and an identifier (code) given to the classification item and attribute to configure each hierarchical structure. Accordingly, if the schema information of the same version information and the same identifier are beforehand stored in the corresponding schema memories 8 of the data exchangers 21a and 21b, respectively, it is self-evident what kind of attribute value the contents data registered on the hierarchical structure has, when a classification item to which the contents data belongs is given thereto.

In this case, if each attribute value configuring the contents data specifies certainly an identifier of an attribute to be registered, each attribute value in the contents data can specify what attribute it belongs to. Then, even if the contents data and hierarchical structure (schema data) are completely separated and only contents data is expressed in the simple text format, the data exchanger 21b receiving it has no inconvenience at all.

The input unit 2 is provided for inputting a search condition for obtaining desired contents data and schema from the hierarchical database 10, and for inputting various instructions to the transmission data generator 4, the communications unit 5, and the receive data register 7. The data search unit 3 searches the hierarchical database 10 for contents data to satisfy a searching condition input from the input unit 2 and schema data corresponding to the contents data and displays a search result on the display unit 1. Confirming the contents displayed on the display unit 1, a user designates data to be transmitted to the data exchanger 21b as transmission data from the input unit 2.

The transmission data generator 4 converts contents data stored in the contents memory 9 to text data such as CSV to generate transmission data (first transmission data) to be transferred to a destination (data exchanger 21b). The transmission data generator 4 converts schema data stored in the schema memory 8 to text data such as CSV to generate transmission data (second transmission data) to be transferred to a destination (data exchanger 21b). More concretely, the transmission data generator 4 acquires an identifier to identify schema of contents data to be transmitted from the schema memory 8 and generates a tag of a structured document according to a classification item.

The contents data is described in a text format, and surrounded by an ending tag. Further, when the data is to be compressed, the transmission data generator 4 compresses a text data part, and attaches compression format information to the structured document tag by inputting a compression method from, for example, the input unit 2 to the transmission data generator 4.

When the contents data to be transmitted extends over a plurality of classes, and parts gathered up in each class are associated to each other, the relevant information is described to the structured document. The transmission data (hierarchical structures data and attributes data) generated by the transmission data generator 4 are transmitted to a destination (data exchanger 21b) designated with the input unit 2 from the communications unit 5. When the communications unit 5 receives the first and second transmission data through a network, at first they are sent to a receiving data analysis unit 6. The receiving data analyzer 6 checks whether schema corresponding to the contents data received by the first transmission data exists in the schema memory 8, based on version information of schema of the first transmission data.

In addition, if the received first and second transmission data were compressed, the data are uncompressed. After the receiving data analyzer 6 subjects the first and second transmission data to a necessary process, the contents data and schema data of the first and second transmission data are transferred to the receiving data register 7. The receiving data register 7 carries out a process to register the received contents data and schema data with a hierarchical database 10.

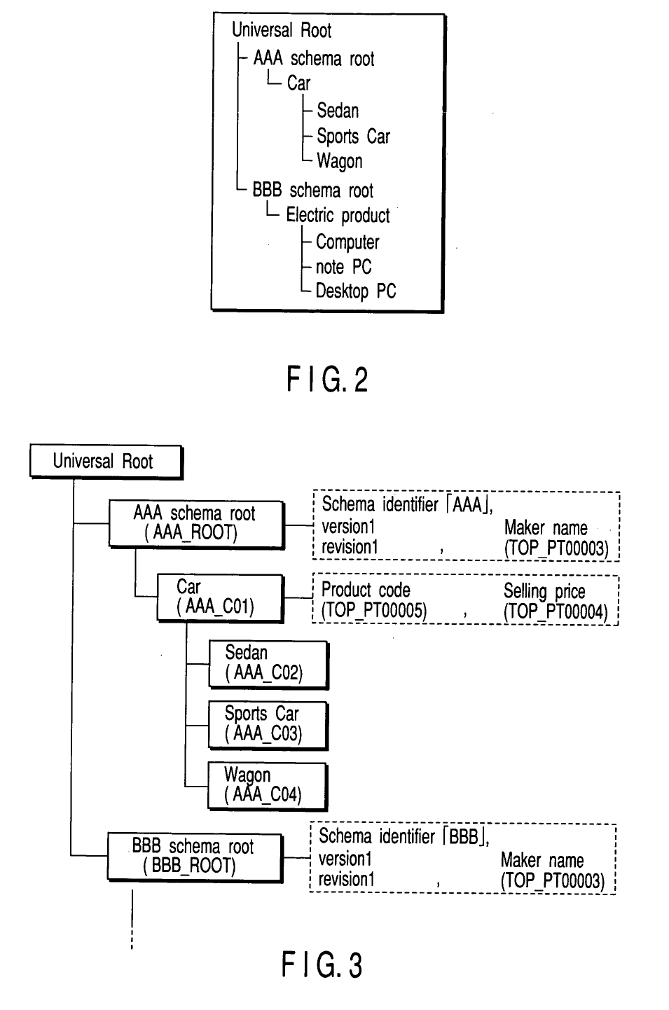

FIG. 2 illustrates schematically a hierarchical structure of the hierarchical database 10. As shown in FIG. 2, the hierarchical database 10 assumes a classification item of “Universal” as a root node, and connects two hierarchical structures to the root node to form a single hierarchical structure. The two hierarchical structures include a hierarchical structure of a schema identifier “AAA” referred to as the first hierarchical structure or the first schema), and a hierarchical structure of a schema identifier “BBB” referred to as the second hierarchical structure or the second schema. In other words, a root node “AAAschemaroot” of the first hierarchical structure as a child node of “Univesal” and a root node “BBBschemaroot” of the second hierarchical structure are associated with each other. The node “AAAschemaroot” is associated with a node of the classification item of “Car” as its child node. The “Car” node is associated with a node of classification items of “Sedan”, “SportsCar” and “Wagon”.

This represents that “Universal” is subdivided in two classification items of “AAAschemaroot” and “BBBschemaroot”, and the item “AAAschemaroot” includes a classification item of “Car”, which is subdivided in three classification items of “Sedan”, “SportsCar” and “Wagon”. The hierarchical structure shown in FIG. 2 has two hierarchical structures of “AAA” and “BBB”.

A schema identifier to distinguish between version information of the hierarchical structure and the hierarchical structure is stored in each hierarchical structure. In this example, as shown in FIG. 3, version information “version1 and revision1” are stored in the hierarchical structure below the “AAAschemaroot” node and a hierarchical structure below the “BBBschemaroot” node, respectively. Further, the schema identifiers “AAA” and “BBB” are stored in respective hierarchical structures.

The classification items associated with each other in hierarchy are defined by inherent attributes (a part surrounded with a dotted line), respectively. Each classification item succeeds to the attribute of the classification item of a higher hierarchical layer of the classification item in the hierarchical structure. For example, the attribute having the “Car” node succeeds to the inherent attribute of the node “AAAschemaroot” of the higher order than the “Car” node as well as the inherent attribute of the “Car” node oneself. In other words, the “Car” node comprises an attribute (maker name) defined by the “AAAschemaroot” node and an attribute (“product code”, “selling price”) defined by the “Car” node. In other words, it comprises “Car” node inherite attributes of upper nodes.

In addition, a “Sedan” node succeeds to the inherent attributes of the “Car” node and “AAAschemaroot” node higher than the “Sedan” node. In other words, the “Sedan” node has an attribute (“product code”, “selling price”) defined by the “Car node and an attribute (“maker name”) defined by the “AAAschemaroot” node.

Such a data model is substantially the same as that used in ISO13584/PartsLibrary (PLIB) that is the international standard of a replacement format of a parts library. PLIB uses a BSU code assured that it is a unique code in the world as a code system identifying each classification and attribute. For simplification of description, a classification identifier to identify the classification item and an attribute identifier to identify the attribute, that have a role similar to the BSU code, are described with the parenthesized classification item name and attribute name as shown in FIG. 3.

Each hierarchical structure is referred to as schema. The information representing the hierarchical structure (for example, information representing, for example, a plurality of classification items forming the hierarchical structure, foliation between the classification items (connection relation of the classification items), an attribute determined to each classification item) is referred to as schema data.

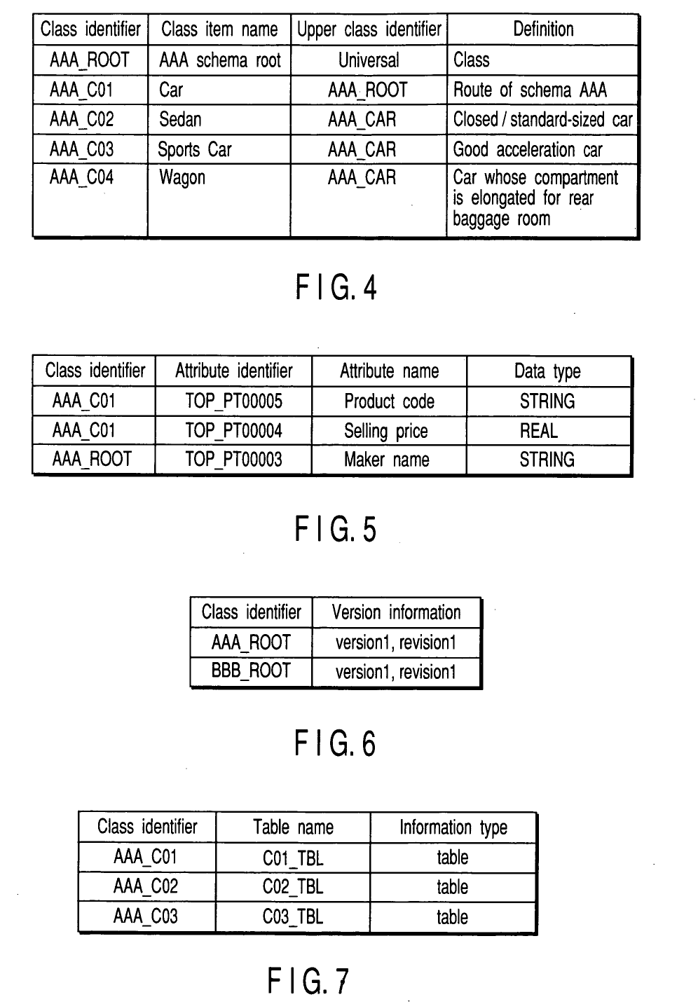

Each schema has a schema identifier such as “AAA” or “BBB” and version information. This schema identifier and version information are information included in each schema data. The classification items and the hierarchical structure configured thereby as shown in FIGS. 2 and 3 are stored in the schema memory 8 with a classification identifier of each classification item, a classification item, and a classification identifier of a classification item that is a parent node of the former classification item as shown in FIG. 4, for example.

The attribute of each classification item is stored in the schema memory 8 with a classification identifier of a classification item, an attribute identifier of the inherent attribute thereof, an attribute name, and a data type of the value of the attribute as shown in FIG. 5, for example. In FIGS. 4 and 5, the classification identifier of each classification item includes a schema identifier of the schema belonging to the classification item. Therefore, it can identify what the schema belonging to the classification identifier is.

FIG. 6 shows a storage example of version information of the schema stored in the schema memory 8. Version information of schema corresponding to the hierarchical structure below the classification item is stored in a classification identifier of the classification item corresponding to the head node of the hierarchical structure belonging to each schema. The data shown in FIGS. 4, 5 and 6 corresponds to the schema data.

The version information comprises a version and a revision. When the schema data is largely revised from the original schema, the value of the version is incremented by one. When the schema data is slightly revised from the original schema, the value of the version assumes to be incremented by one without being updated. The schema can be uniquely specified by the schema identifier and version information.

The contents data configured with a value corresponding to each of the attribute of the classification item (an attribute inherent to the classification item and an attribute succeeded to an attribute classification item corresponding to a higher hierarchy than the former classification item) is registered with each classification item shown in FIG. 3. In the contents memory 9 is stored contents data corresponding to each of the classification items stored in the schema memory 8.

The contents data stored in the contents memory 9 is shown in FIGS. 7 to 9. FIG. 7 shows a table for storing contents data corresponding to the classification item “Car (classification identifier AAA_C01), classification item “Sedan” (classification identifier AAA_C02) and classification item “SportsCar” (classification identifier AAA_C03). Because the contents data is stored in a table format, each classification identifier and each table name are stored in association with each other in the table shown in FIG. 7. Each table name stores contents data corresponding to the classification item corresponding to the classification identifier.

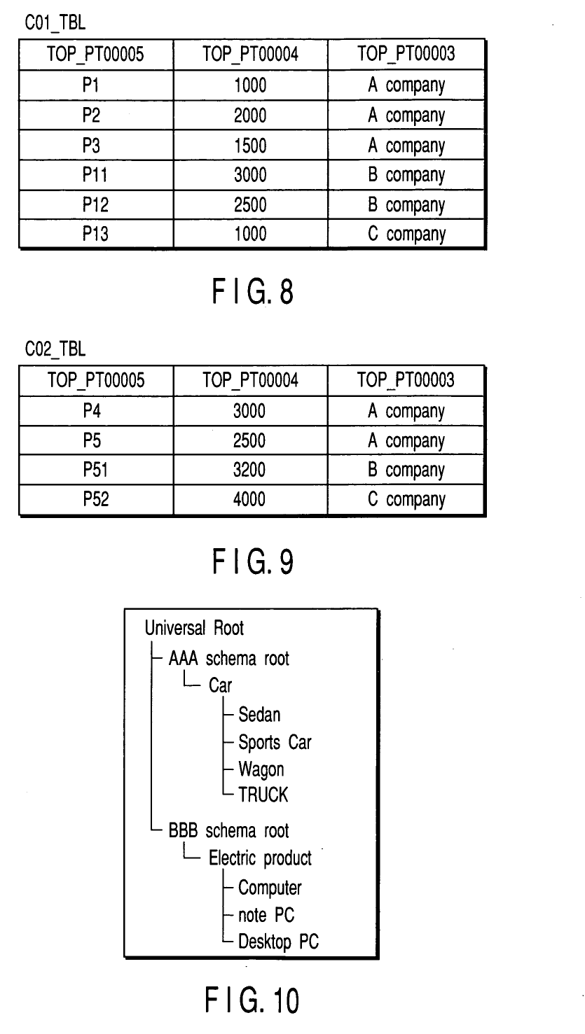

FIG. 8 shows a storage example of the classification item “Car” (table (C01_TBL) described with the contents data corresponding to the classification identifier AAA_C01). FIG. 9 shows a storage example of the classification item “Sedan” (table (C01_TBL) described with contents data corresponding to the classification identifier “AAA_C02”). Since the classification item “Car” and the classification item “Sedan” each have “maker name” (attribute identifier TOP_PT00003), “selling price” (attribute identifier TOP_PT00004), and “product code” (attribute identifier TOP_PT00005). As shown in FIGS. 8 and 9, each record data is configured by a value corresponding to each of three attributes.

A data transfer between data exchangers each having a construction shown in FIG. 1 will be described. In the present embodiment, in order to transfer data (contents data and schema data corresponding to the contents data) stored in the hierarchical database 10 of the data exchanger 21a to the data exchanger 21b, and store it in the hierarchical database 10, at first contents data searched from the hierarchical database of the data exchanger 21a is transmitted to the data exchanger 21b. In this case, an identifier (a schema identifier) of schema corresponding to the contents data and version information are included in the transmission data (first transmission data).

The contents data are divided by a comma between the attribute values composing the contents data every classification item belonging to each contents data. In other words, the contents data is formed in a simple text format to divide with a line feed code between contents data, so-called CSV (comma separated value). The embodiment uses a comma as a delimiter code (a first delimiter code) for delimiting between attribute values configuring the contents data, and uses a line feed code as a delimiter code (a second delimiter code) for delimiting between contents data. However, the delimiter code is not limited to the above. For example, a colon (:), a semicolon (;), a tabulation code, etc. as well as the comma may be used as the first delimiter code.

In addition, for example, a period (.) code may be used as the second delimiter code. Further, a colon (:), a semicolon (;), a tabulation code, etc. may be used, if they indicate a stronger delimiter than the code used as the first delimiter code. Although both of contents data and schema data should be sent conventionally, the contents data and schema are completely separated, and at first only contents data is transmitted. Because the contents data in the transmission data is a simple CSV format as described above, it is possible to shorten a processing time to generate transmission data, and to reduce the amount of the transmission data.

When the receiving data exchanger 21b receives the first transmission data, the data exchanger 21b determines whether schema data specified by a schema identifier and version information included in the first transmission data are stored in the schema memory 8 of the data exchanger 21b. If the schema memory 8 includes no specified schema data, the data exchanger 21b requests the data exchanger 21a to provide the schema. When received this request, the data exchanger 21a transmits the schema data as the second transmission data to the data exchanger 21b. In this case, the schema data is transmitted in a CSV format. In other words, the schema data of the second transmission data is divided into data on each classification item (refer to FIG. 4) and data on an attribute defined by the classification item (refer to FIG. 5). The second transmission data is transmitted as text data with being divided between items configuring the data by a comma (,), a colon (:), a semicolon (;), a tabulation code, a period (.), a line feed code, etc.

Since the schema data is transmitted in a CSV format in this way, too, it is possible to decrease a processing time required for generating transmission data and an amount of the transmission data. To separate contents data and hierarchical structure, and transmit only contents data first and then transmit the contents data and schema data in a CSV format is based on assumption that the transmitting and receiving data exchangers 21a and 21b can interpret the same schema respectively. When the contents data received on the receiving side cannot be understood, that is, when the contents data has no schema corresponding to a schema identifier and schema corresponding to version information included in the first transmission data, schema data is transmitted for the first time.

If it is understood on the transmitting side that the receiving data exchanger 21b has no schema corresponding to the contents data to be sent from now, the schema may be sent together with contents data. In this case, the contents data and schema data are transmitted in a CSV format. Accordingly, it is possible to decrease a processing time for generating transmission data and reduce a data amount of the transmission data.

There will be explained version of schema data. As explained above, the schema can uniquely specify a schema identifier from version information (combination of values of version and revision). The compatibility can be determined by the version information. In other words, concerning the schema of a certain schema identifier, if the version information of the schema stored in the schema memory 8 of the data exchanger 21b which is a destination is the same as the version information of the schema stored in the schema memory 8 of the data exchanger 21a which is a departure, that is, version information of the schema that has been sent from the data exchanger 21a to data exchanger 21b along with contents data, or if it is new, that is, if the values of revision and revision are the same or the value of version is larger than that of revision, or if the value of version is the same but that of revision is larger than that of version, it is possible to apply the schema stored in the schema memory 8 to the contents data transmitted by the data exchanger 21a. In other words, the data exchangers 21a and 21b are compatible.

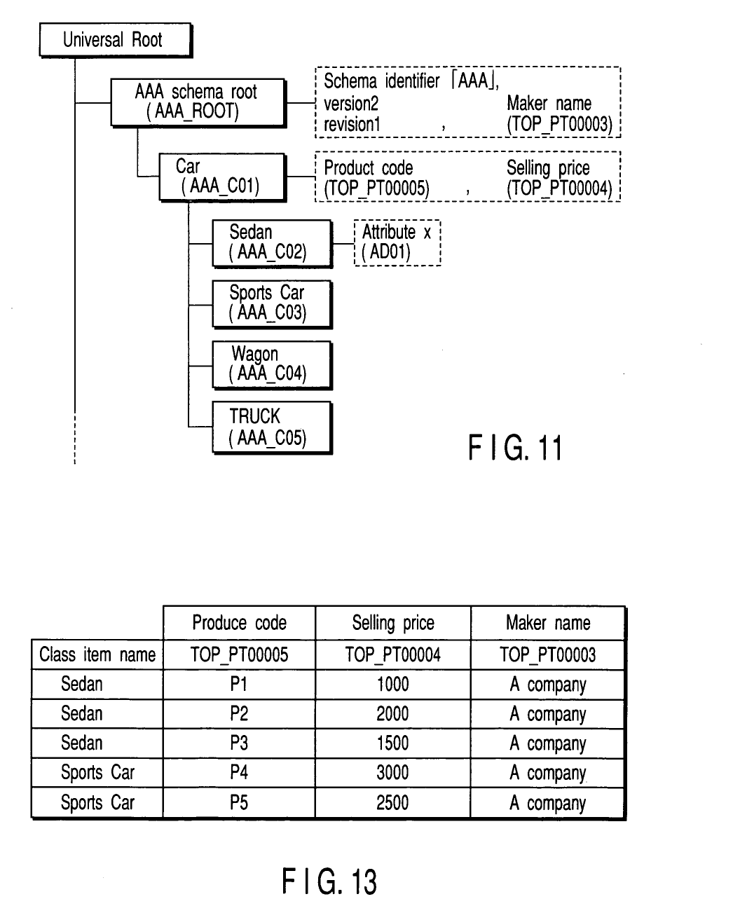

However, when the version information of the schema stored in the schema memory 8 of the data exchanger 21b is older than the version information of the schema that has been sent from the data exchanger 21a to the data exchanger 21b along with the contents data, that is, when the value of version is small or when the value of version is the same but the value of revision is small, the schema stored in the schema memory 8 cannot be applied to the contents data transmitted by the data exchanger 21a. Because, in an old version, the classification item and the attribute that are not defined are added to contents data corresponding to the schema of a new version transmitted by the data exchanger 21a. Alternatively, the classification item and attribute defined with the old version may be deleted. Therefore, the contents data corresponding to schema of this new version cannot be interpreted precisely. For example, in the schema memory 8 of the transmitting data exchanger 21, it is assumed that the schema of the schema identifier “AAA” is version-upgraded, the classification item of “TRUCK” is added as a child node of the classification item “Car” as shown in FIG. 10, and a new attribute of “attribute x” is added to the classification item “Sedan.” The status of the hierarchical database in this time is shown in FIG. 11. The version information of schema of the schema identifier “AAA” is “version2, revision1” as shown in FIG. 11. This is stored in the “AAAschemaroot” node.

The item “Attribute x (Attribute identifier AD01)” is added to the “Sedan” node. If the schema of the schema identifier “AAA stored in the schema memory 8 of the receiving data exchanger 21b is upgraded in version, that is, if the version information is updated in the schema of “version2, revision1”, even if contents data corresponding to this schema is received, it can be registered to the contents memory 9. However, it is assumed that the schema of a structure shown in FIG. 2 is stored in the schema memory 8 of the receiving data exchanger 21b without updating the schema of the schema identifier “AAA”. In other words, it is assumed that the version information of the schema of the schema identifier “AAA” is “version1, revision1”. The status of the hierarchical database in this time is shown in FIG. 3.

In this case, even if the contents data corresponding to the schema of the schema identifier “AAA” transmitted by the data exchanger 21a is received, for example, the transmission data of a structured document of description as shown in FIG. 24 is received, the data exchanger 21b cannot interpret it. It is not possible to recognize “attribute x (attribute identifier AD01)” and a value (“abc” “def” “ghi” of the 5th to 7th lines of FIG. 24) of contents data value corresponding thereto, that are added newly to the classification item of “TRUCK shown in FIG. 24 or the classification item of “Sedan”. Consequently, it cannot be registered with the contents memory 9. In this case, the data exchanger 21b has to request the data exchanger 21a to provide schema of a new version. When receiving this request, the data exchanger 21a reads, from the schema memory 8, version which is schema of the schema identifier “AAA” and whose version information is “version2, revision1”, and transmit it to the data exchanger 21b.

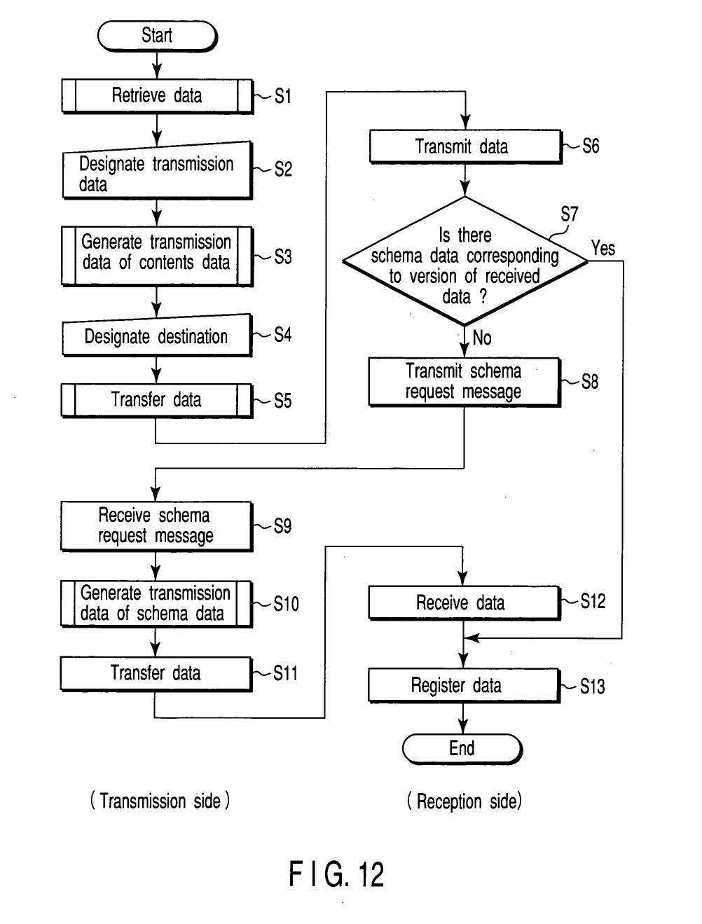

A data transfer between the data exchangers 21a and 21b shown in FIG. 1 is described in detail with reference to the flowchart shown in FIG. 12. It is assumed that the hierarchical database 10 of the data exchanger 21a is the status shown in FIG. 3. At first, there will be explained a process-operation of the transmitting data exchanger 21a.

A user inputs a searching condition to the input unit 2 to acquire the contents data to be transmitted to the data exchanger 21. Receiving this, the data search unit 3 searches for contents data to satisfy an input searching condition (step S1). The searching condition may be, for example, only a key word, but also one specifying the classification item in the hierarchical database 10. An attribute and a character string included in the value of the attribute may be given as a searching condition. In addition, it is possible to designate a search range.

For simplification of description, there will be described a case to give a search range, an attribute and a character string included in the value of the attribute as a searching condition. Assuming that there is input a search condition wherein a node corresponding to, for example, the classification item “Car” on and after is searched for the contents data that the value of an attribute “maker name” is “A company”. In this search condition, a descendant node of the node corresponding to the classification item “Car” is designated as a search range, the “maker name” is designated as an attribute, and the “company” is designated as the value thereof. On the basis of this search condition, the data search unit 3 searches for the schema stored in the schema memory 8 and contents data stored in the contents memory 9, to retrieve the node corresponding to the classification item “Car” on and after for the contents data that the value of the attribute “maker name” is “A company.”

In other words, there are “Sedan”, “SportsCar” and “Wagon” as child nodes of the classification item “Car” as indicated in FIG. 3. Therefore, the contents data belonging to these four classification items, respectively are searched for content data that the attribute “maker name” is “A company”.

A method of searching for contents data to satisfy the search condition on the basis of the search condition may use a well known method and thus its description is omitted. It is assumed that five contents data are acquired as a search result as shown in FIG. 13. The search result is displayed on a display unit 1.

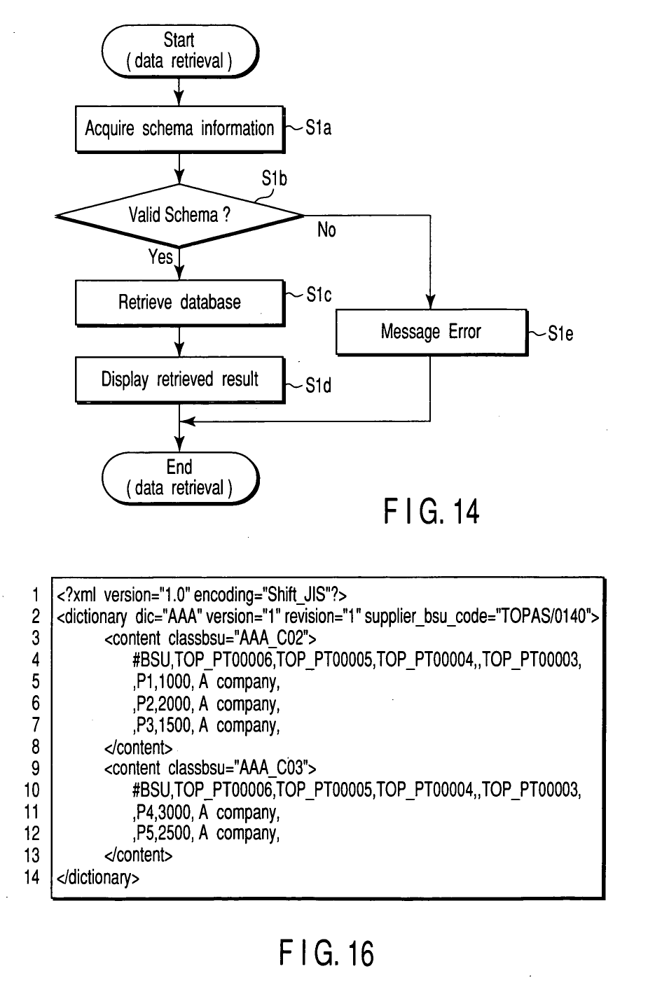

The data search process in step S1 of FIG. 12 is shown in detail in FIG. 14. According to the process, at first, schema data is read from the schema memory 8 to display an input screen to input a search condition (step S1a). It is determined whether the read schema data is valid (step S1b). If the determination is YES, the process advances to step S1c. If it is NO, an error message is displayed on the display unit 1 and the search process is canceled (step S1e).

In step S1c, the contents data is searched for according to the search condition input by a user on the search condition input screen displayed based on the read schema data. Search results are displayed on the display unit 1. The data search unit 3 searches for contents data to satisfy the input search condition, and acquires schema data corresponding to the contents data. In this case, the node of the classification item “Car” on and after is designated as a search range, and thus the schema is a schema including this classification item, too. This is the schema of the schema identifier “AAA” as understood by the hierarchical structure shown in FIG. 3. In this time, version information of the schema is acquired.

In FIG. 12, it is assumed that the user ensures search results displayed on the display unit 1, and all contents data provided as the search results are designated as data to be transmitted (step S2). In this time, the transmission data generator 4 generates transmission data to transmit the designated contents data (step S3). The transmission data (transmission data to transmit the contents data, referred to as the first transmission data) includes an identifier of the schema provided as the result searched with the data search unit 3 and version information and transmission contents data written in a CSV format as described above.

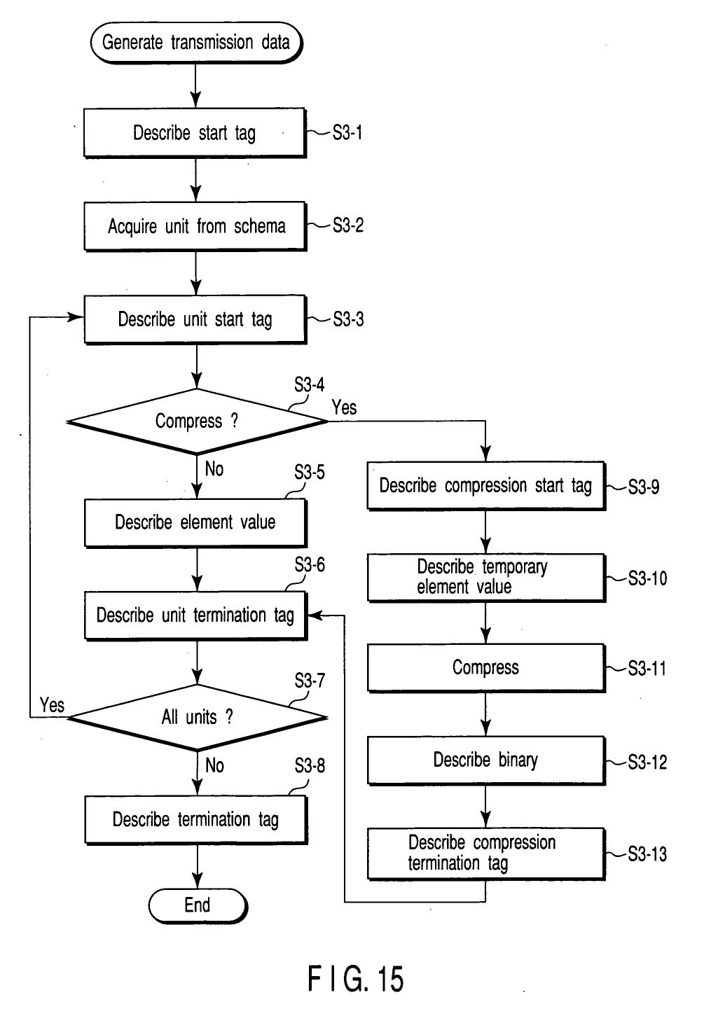

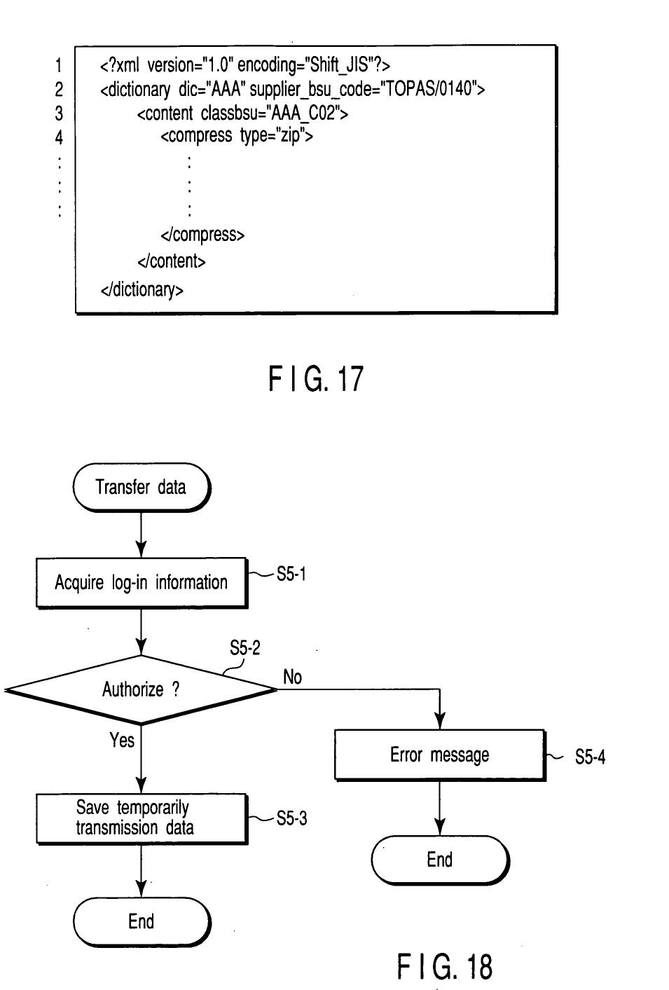

A transmission data generation process of the transmission data generator 4 will be described in detail according to flowchart shown in FIG. 15. FIGS. 16 and 17 show an example of the first transmission data generated with the transmission data generator 4. FIG. 16 shows the first transmission data generated without compressing contents data. FIG. 17 shows the first transmission data compressing contents data. There is described a case that the transmission data is, for example, a structured document as shown in FIGS. 16 and 17, and an XML document described in XML.

The transmission data generation process is described referring to FIGS. 16 and 17.

In step S3-1:

At first, header information of transmission data is generated. As shown in FIG. 16, a tag <?xml version=“1.0” encoding=“Shift_JIS”?> of the first line is generated as header information. To be encoded in a shifted JIS code is described here.

As shown in FIG. 16, a tag <dictionary dic=“AAA” supplier_bsu_code=“TOPAS/0140”> of the second line is generated as header information. The identifier “AAA” of the schema corresponding to contents data to be transmitted and the version information “version1 “revision1” of the schema are described here.

A tag “supplier_bsu_code” of the second line is an identification code corresponding to a group having responsibility for insurance of schemas (referred as to a supplier hereinafter). Data concerning the supplier is omitted from the hierarchical database 10 shown in FIG. 2 or FIG. 3. However, the information on the supplier is included certainly in the schema information.

In step S3-2:

The classification item belonging to the contents data to be transmitted is extracted from the schema obtained by the searched result of the data search unit 3. Because the contents data to be transmitted belongs to two kinds of classification items: “Sedan” and “SportsCar” as indicated in FIG. 13, the two classification items are derived from the schema of the schema identifier “AAA”.

The contents data to be transmitted every classification item are gathered up, and it is described as an element configuring an XML document as transmission data. The element of each classification item is referred to as a unit, too.

In step S3-3:

A tag (unit beginning tag) of an element (unit) configuring the XML document as transmission data from each of the classification items acquired in step S3-2 is generated one by one. At first, a tag of <content classbsu=“AAA_C02”> is formed as shown in the third line of FIG. 16 using the classification identifier “AAA_C02” of the first classification item “Sedan.”

In step S3-4:

When data compression is done every unit, the process advances to step S3-5. When data is not compressed, the process advances to step S3-9.

In step S3-5:

The contents data belonging to the classification item corresponding to the unit beginning tag is described in a CSV format as a value of the unit beginning from the unit beginning tag formed in step S3-3.

The contents data belonging to the classification item “Sedan” comprises values of three attributes “product code”, “selling price” and “maker” according to FIG. 13. At first, the identifier of each attribute as an element value is described as being delimited by a comma, and followed by a line feed code last. The result corresponds to the fourth line of FIG. 16.

Next, as to each contents data (of three contents data in this example), each attribute value is described as being delimited by a comma. A line feed code is inserted after the last attribute of each contents data was described (a new paragraph is started). As a result, each contents data is described for each Line as shown in 5th to 7th lines of FIG. 16. In this way, when description finishes for all contents data, the process advances to step S3-6, and the ending tag of the unit is described as shown in 8th line of FIG. 16.

Next, the process returns to step S3-3, a next unit beginning tag is formed.

In step S3-3:

A tag of <content classbsu=“AAA_C03”> is formed as shown in the ninth line of FIG. 16 using the classification identifier “AAA_C03” of the second classification item “SportsCar.” When compression is not done similarly to the above, the process advances to step S3-5, and contents data belonging to the classification item corresponding to the unit beginning tag as the value of the unit is described in a CSV format.

The contents data belonging to the classification item “SportsCar” comprises the values of three attributes of “product code”, “selling price” and “maker” according to FIG. 13 similarly to the above. Consequently, the identifier of each attribute is described as the element value as being delimited by a comma, and a new paragraph is started. Thereafter, concerning each contents data (of two contents data in this example), each attribute value thereof is described as delimited by a comma. A new paragraph is started after the last attribute value of each content data is described. The result is shown in 10th to 12th lines of FIG. 16.

When all contents data finishes to be described, the process advances to step S3-6 to describe the ending tag of the unit as shown in 13th line of FIG. 16.

In step S3-7:

When generation and description of all units are finished, the process advances to step S3-8 to describe the ending tag as shown in 14th line of FIG. 16, and generation of transmission data (first transmission data in this example) is finished.

There will now be explained an example of compressing the value of each unit in step S3-4 of FIG. 15 referring to the transmission data shown in FIG. 17. In this case, at first, the process advances to step S3-9 to describe a compression beginning tag (the fourth line of FIG. 17) following a unit beginning tag (the third line of FIG. 17). In this compression beginning tag <compress> a compression format to apply thereto is described.

The element value regarding the unit is described in a temporary file in a CSV format similarly to step S3-5, and then the contents of the file obtained as a result of having done a given compression process to the temporary file is described in a binary format (steps S3-11 and S3-12). The ending tag of the unit is described (step S3-6) after the compression ending tag <compress> is described (step S3-13).

When the first transmission data is generated as shown in FIGS. 16 and 17 in this way, a destination of the first transmission data is designated by a user. The destination can be designated by symbolizing the first transmission data on a GUI screen, and displaying its symbol, and dragging and dropping the symbol on a symbol of the destination (data exchanger 21b) which is displayed on the GUI screen. When the destination is designated, the first transmission data is transmitted from communications department 5 to the destination (data exchanger 21b) (step S5).

A data transmission process of step S5 is described in detail with reference to flowchart shown in FIG. 18. When the data exchanger 21a receives a data transfer designation from a user (input unit 2), it requests log-in information for the user. As a result, the data exchanger 21a receives the user log-in information input from the input unit 2 (step S5-1).

The data exchangers 21a and 21b store in a memory unit (not shown) information representing whether each user employing the data exchanger has the authority for executing a data transfer process. It is necessary to request log-in information for a user to search such information.

When information stored in the memory unit is searched fro according to the log-in information input from input unit 2, the user is determined to have the authority for executing the data transmission process. When this situation is confirmed (step S5-2), the transmission data is saved in the memory region for storing data temporarily, to transmit the transmission data from the communications unit 5 (step S5-3). Then, the communications unit 5 reads the transmission data from the memory region, and starts to transmit it to the destination (data exchanger 21b).

As described above, when the first transmission data is transmitted by the data exchanger 21a, and the communications unit 5 of the data exchanger 21b receives the first transmission data, the data exchanger 21b starts a process operation (step S6 in FIG. 2).

The received first transmission data is sent to the receive data analyzer 6. The receive data analyzer 6 derives a schema identifier (AAA) included in header information of the received first transmission data and version information (“version1”, revision1) of the schema, and then confirms whether schema data (including compatible schema data) corresponding to the schema identifier and version information is stored in its own schema memory 8 (step S7).

As explained above, when the schema data of the schema identifier “AAA” is not stored in the schema memory 8, or when the schema data of the schema identifier “AAA” is stored in the schema memory 8 but its version information is older than the version information included in the first transmission data, a schema request message is transmitted from the communications unit 5 for requesting the schema data for the data exchanger 21a (step S8).

On the other hand, in step S7, when the schema data of the schema identifier “AAA” whose version information is the same as the version information included in the first transmission data or new is stored in the schema memory 8, the process advances to step S13 to start a process to register contents data included in the received first transmission data with the contents memory 9.

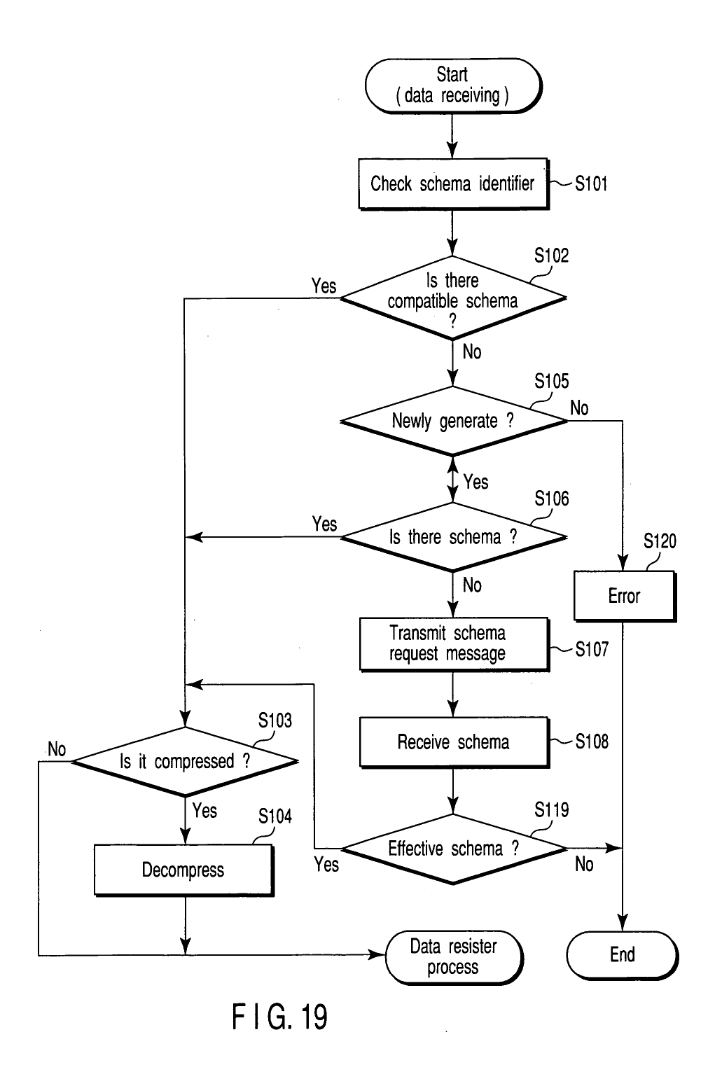

The data reception process of steps S6 to S8 of FIG. 12 is described in detail referring to flowchart shown in FIG. 19. When communications unit 5 receives the first transmission data shown in FIG. 16, it derives a schema identifier and version information included in the first transmission data as explained in step S7. In other words, in the case the transmission data shown in FIG. 16, the communications unit 5 derives the schema identifier “AAA” described in the attribute “dic” of a tag <dictionary> of the second line and values described in the attributes “version” and “revision” respectively.

The schema memory 8 is searched for determining whether the schema of the schema identifier “AAA” is stored in the schema memory 8. In the case that the schema of the schema identifier “AAA” is stored in the schema memory 8, when the values of the “version” and “revision” are the same as that of the first transmission data or when they are different therefrom but the receiving side one is new, it is determined that they are compatible (step S102). However, an error checking is necessary at the time of a registration of contents in individual classification again.

When the compatible schema exists, the process advances to uncompression of step S103. When no compatible schema exists (step S102), the process advances to step S105. It is confirmed for the data exchanger 21b of a user whether the schema data that is not stored in the schema memory 8 now should be newly registered or updated in step S105. When the user designates registering the schema data newly or updating, the process advances to step S106. When the registering or updating is not designated, the process advances to step S120 to carry out an error process, and then the process is finished.

In step S106, it is confirmed whether the schema identifier included in the header information of the received first transmission data and the schema data coinciding with the version information are included in the first transmission data.

FIG. 15 shows a case to send contents data without sending schema data. If the receiving data exchanger 21b comprehends that a transmitting side does not have a schema corresponding to the contents data that it is going to send from now, the receiving data exchanger 21b can send the schema together with the contents data.

When the schema identifier included in the header information of the received first transmission data and the schema data coinciding with the version information are included in the first transmission data, the process advances to step S103. When they are not included, the process advances to step S107 to send a schema request message to the data exchanger 21a.

On the other hand, it is confirmed in step S103 whether contents data in each unit in the received first transmission data is compressed. When the compression beginning tag <compress> is included in a unit, the contents data in the unit is compressed. In this case, the data in such the unit is uncompressed (step S104).

Since a compression system is described as a “type” attribute of a <compress> tag as indicated in the 4th line of FIG. 17, an uncompression corresponding to the compression system may be done. The contents data in each unit after an uncompression process and the contents data which is not compressed are sent to the receive data registration unit 7 to register the data.

There will now be explained a case that the data exchanger 21b transmits a schema data request message to the data exchanger 21b in step S107 of FIG. 19 (step S8 of FIG. 12) referring to FIG. 12. When the data exchanger 21a receives a schema request message transmitted by the data exchanger 21b (step S9), the transmission data generator 4 generates transmission data (the second transmission data) for transmitting the schema data of the version information “version1, revision1” with the schema identifier “AAA” provided previously by a data search process (step S10). An operation of generating the second transmission data is approximately similar to that of the first transmission data.

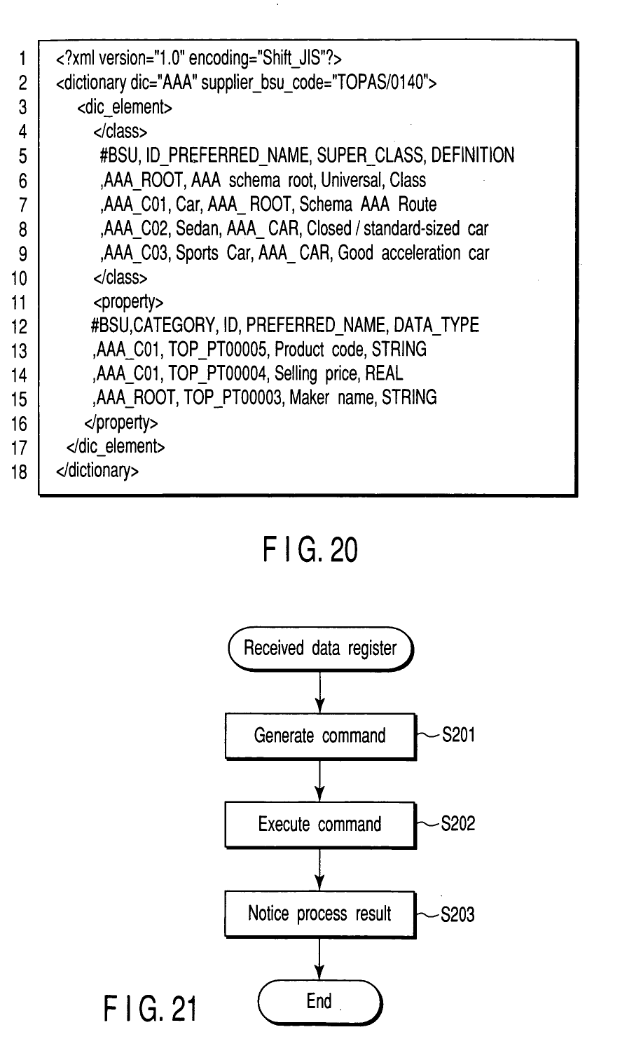

There will be explained an operation of generating the second transmission data for transmitting the schema data of version information “version1, revision1” with the schema identifier “AAA” as shown in FIG. 20, referring to flowchart of FIG. 15. The process different from that of the first transmission data is mainly described.

In step S3-1:

At first, header information of the second transmission data is formed similarly to the first transmission data. A tag <?xml version=“1.0” encoding=“Shift_JIS”?> of the first line and a tag <dictionary dic=“AAA” supplier_bsu_code=“TOPAS/0140”> of the second line are generated as header information as shown in FIG. 20.

In step S3-2:

The data shown in FIG. 4 and concerning each classification item of the schema (schema of the schema identifier “AAA”) provided by a search result of the data search unit 3, and the data shown in FIG. 5 and concerning the attribute are read from the schema memory 8.

In this example, the schema data are divided into data on the classification item of the schema (data shown in FIG. 4) and data on the attribute (data shown in FIG. 5). Each data is described as an element configuring an XML document as transmission data.

The element corresponding to each of the data on the classification item of this schema and the data on the attribute is referred to as a unit.

In step S3-3:

At first, a tag <dic_elemnt> representing a schema is described as shown in the third line of FIG. 20. Thereafter, a tag (a unit beginning tag) corresponding to each of the data on the attribute and the data on the classification item of the schema acquired in step S3-2 is formed. The first beginning tag of the unit for describing the data on the classification item of the schema, that is, a <class> tag (on the 4th line of FIG. 20) is formed.

Instep S3-4:

When a data compression is carried out every unit, the process advances to step S3-9. The process advances to step S3-5 when the data compression is not done.

In step S3-5:

The data on the classification item as shown in FIG. 4 is described in a CSV format as a value of a unit starting at the unit beginning tag formed in step S3-3.

As to each classification item composing the schema “AAA”, data is described for each field of “classification identifier”, “classification item name”, “upper classification identifier” or “definition” as shown in FIG. 4. Therefore, at first these fields are described as delimiting each field name with a comma and a line feed code is attached to a last field. The result corresponds to the 5th line of FIG. 20.

Next, as to each classification item, the data of each field is described as delimiting with a comma, and a line feed code is attached to the last field (a new paragraph is made) after the data of the last field of each classification item is described. As a result, as shown in the 6th to 9th lines of FIG. 20, data on each classification item is described for each Line.

In this way, when description of data on all classification items configuring the “AAA” schema, the process advances to step S3-6 to describe an ending tag of the unit as shown in the 10th line of FIG. 20. Thereafter, the process returns to step S3-3 to generate a next unit beginning tag.

In step S3-3:

A second beginning tag of a unit for describing the data on the attribute, that is, a <property> tag (on the 11th line of FIG. 20) is formed. Like the above, when data is not compressed, the process advances to step S3-5 to describe, as a value of the unit, data on the attribute in a CSV format as shown in FIG. 5.

As shown in FIG. 4, as to the attribute of each classification item configuring the schema “AAA”, data is described for each of fields of the “classification identifier” in which the attribute is defined, and the “attribute identifier”, “attribute name” and “data type” of the attribute. Therefore, at first, these fields are described as delimiting each field name with a comma, and a line feed code is attached to a last field. The result corresponds to the 12th line of FIG. 20.

As to each attribute, data is described as delimiting each field with a comma. A line feed code is attached to a last field (a new paragraph is made) after the data of the last field of each attribute is described. As a result, data on each attribute is described for each as shown in the 13th to 15th lines of FIG. 20. When data on all attributes of the classification item configuring the “AAA” schema had been described in this way, the process advances to step S3-6 to describe an ending tag of the unit as shown in the 16th line of FIG. 20.

In step S3-7:

When generation and description of all units are finished, the process advances to step S3-8 to describe an ending tag </dic_element>, </dictionary> as shown in the 17th and 18th lines of FIG. 20. Thereafter, the generation of the transmission data (the second transmission data in this example) is finished.

In the case that the value of each unit is compressed in step S3-4 of FIG. 15, a <compress> tag following the beginning tag of the unit may be described and compressed similarly to the case of the first transmission data. When the second transmission data is formed in step S10 of FIG. 12 in this way, the second transmission data is transmitted to the data exchanger 21b (step S11).

When the second transmission data is transmitted by the data exchanger 21a and the communications unit 5 of the data exchanger 21b receives the second transmission data, the data exchanger 21b starts a process operation (step S12). The received second transmission data is sent to the receiving data analyzer 6.

Step S12 of FIG. 12 corresponds to step S108 of FIG. 19. The step S108 is described referring to FIG. 19, hereinafter.

In other words, when the data exchanger 21b receives the second transmission data in step S108 of FIG. 19, the receiving data analyzer 6 extracts the schema data included in the second transmission data, and confirms whether the schema data is schema data applicable to the previously received contents data. For example, the schema identifier and version information of the schema data may be described in the second transmission data, and it may be checked whether it is schema data corresponding to the previously received contents data on the basis of the described ones.

In addition, the schema data may be really applied to contents data to confirm the validity thereof. When the received schema data is not the required schema data, an error processing is done and then the process is finished. When it is the required schema data, a data registration process is carried out (step S13 of FIG. 12).

In data exchanger 21b in step S13 of FIG. 12, a data registration process in the receive data register 7 to register received contents data and schema data with hierarchical database 10 is described referring to flowchart shown in FIG. 21, hereinafter.

The receiving data register 7 generates a command for storing schema data and contents data to the schema memory 8 and contents memory 9 of the hierarchical database 10. The receiving data register 7 sends this command to the hierarchical database 10 to register data actually with each of the memories 8 and 9.

In step S201:

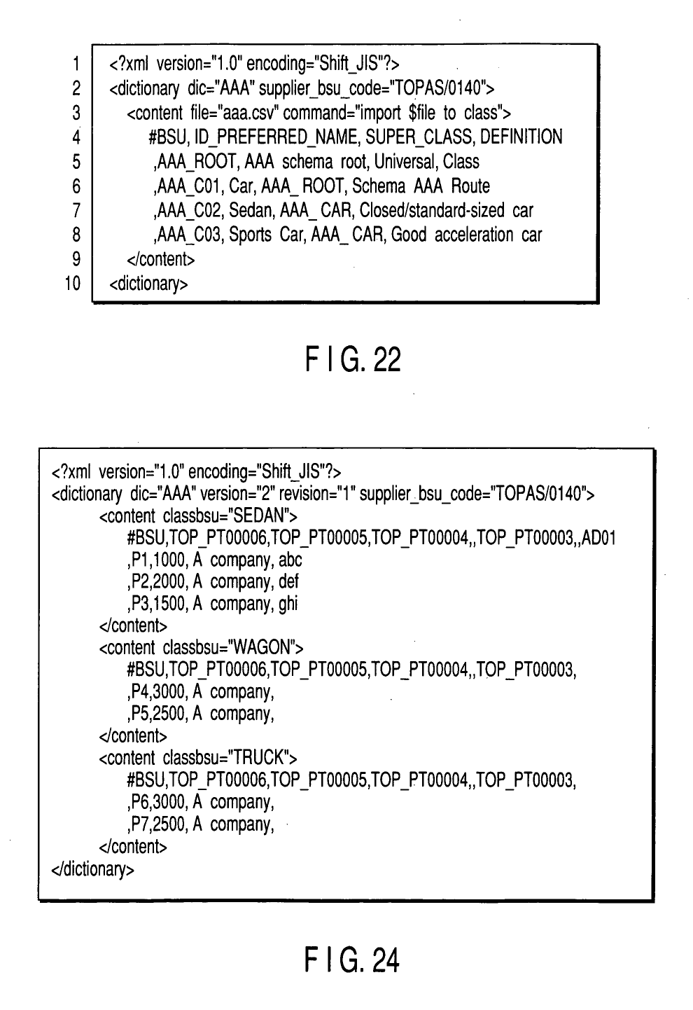

A command for registering the contents data with the hierarchical database as shown in FIG. 22 is generated by the contents data transferred by the data exchanger 21a using the first transmission data, and the schema data stored in the schema memory 8 of the data exchanger 21b or transmitted as the second transmission data by the data exchanger 21a.

A file name (including a path name which is position information of the file name) of a temporary file which temporarily stores the contents data is described in 3rd line in the command. Further, a command executable in the hierarchical database 10 with a certain “command” attribute is described in the same 3rd line. Data on each classification item configuring the schema “AAA” is described in 4th to 8th lines.

In step S202:

This command is sent to the hierarchical database 10 to be executed therein, the contents data and schema included in the command or designated by a user are stored in the contents memory 9 and schema memory 8.

In step S203:

The result that registered these contents data and schema data with the hierarchical database 10 is recorded as history, and the process finishes.

As discussed above, according to the embodiment, in the hierarchical database 10 having a plurality of hierarchical structures of the data exchanger 21a (two schemas of, for example, a schema of a schema identifier is “AAA” and a schema of a schema identifier “BBB”), a plurality of contents data formed of a plurality of attribute values registered with the first hierarchical structure (schema of a schema identifier “AAA”) of the plurality of hierarchical structures to the data exchanger 21b. In this case, an identifier and version information of the first hierarchical structure and first transmission data shown in FIG. 16 and including a plurality of contents data as text data (this second transmission data may be a structured document) are generated and transmitted to the data exchanger 21b.

On the other hand, when the schema data (including compatible schema) corresponding to the schema identifier and version information contained in the received first transmission data is not stored in the schema memory 8, the data exchanger 21b received the first transmission data requests such a schema for the destination data exchanger 21a.

If such schema data is stored in the schema memory 8, the contents data contained in the first transmission data can be registered with the hierarchical database of the data exchanger 21b as it is. Therefore, the received contents data is registered afterwards.

The schema (the first hierarchical structure) applied to the transmitted contents data is transferred independently when it is required from the data exchanger 21b. In other words, the second transmission data shown in FIG. 20 and including text data of the schema is generated and transferred to the data exchanger 21b.

As thus described, when the transmitting side transmits contents data, the hierarchical structure is separated from the contents data and transmitted without attaching more detail schema information than the identifier and version information of the schema.

The schema, namely hierarchical structure corresponding to the previously transmitted contents data is transmitted only when it requests from the destination. The contents data and schema are transmitted as simple text data. Consequently, it is possible to shorten a processing time for generating transmission data, and reduce a data volume of the transmission data.

Further, the data volume can be further reduced by converting contents data to be transmitted into text data and then compressing the text data. As thus described, if the meta schema of a model describing schema information accords to a standard of the international standard of ISO 13584 in both of the transmitting and receiving sides, the above embodiment will be an effective data exchange technique.

Further, with assumption that there is a legacy system difficult to shift to new environment easily. In this case, if the hierarchical database 10 including the currently operating schema memory 8 and contents memory 9 is provided on the receiving side, and it is applied to the above embodiment, the receiving data register 7 generates a command including a command capable of being construed by the hierarchical database 10. Therefore, the present embodiment is applicable to the above embodiment easily.

In the embodiment, only contents data is to be transmitted. However, if the transmitting side knows that the receiving data exchanger 21b does not have schema corresponding to the contents data which it is going to send from now, the schema may be sent together with the contents data.

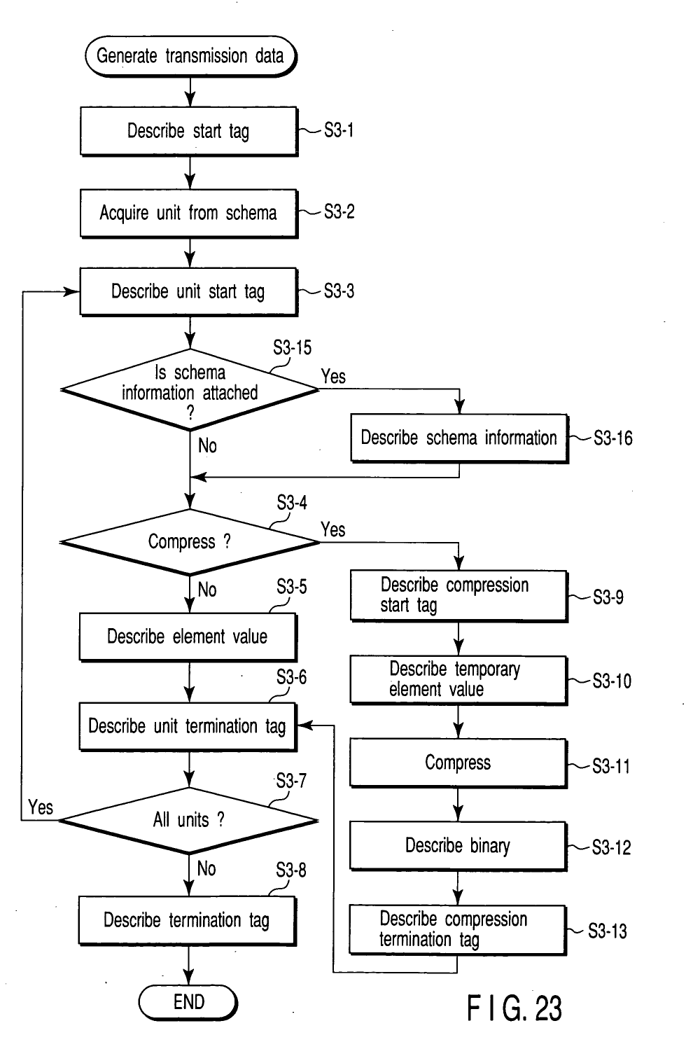

FIG. 23 shows an process operation for generating transmission data for the transmission data generator 4. FIG. 23 uses the same reference number for the same part as that of FIG. 15 and only parts different from FIG. 5 are described hereinafter.

In FIG. 23, in order to write in each unit schema data on the classification item and attribute corresponding to the unit in a text format as described above, steps S3-15 and S3-16 are added between steps S3-3 and S3-4. The data on the classification item corresponding to the unit and data on the attribute of the schema data of the schema identifier “AAA” are inserted as text data by the two steps S3-3 and S3-4.

The process operation of the data exchanger 21b in receiving the transmission data including the contents data which such schema data is attached to has been already described.

The above embodiment carries out a process on the initiative of a transmitting side. However, the process may be carried out on the initiative of a receiving side. For example, the data exchanger 21b notifies the data exchanger 21a of a desired schema identifier and version information. The data exchanger 21a transmits contents data registered with the classification item of a hierarchical structure corresponding to the schema of the schema identifier with text data as described above. In addition, when the schema is updated and becomes new than the notified version information, the schema data of the new version may be transmitted together with the contents data.

Even if the process is carried out on the initiative of the transmitting side before transmission of the contents data, at first the schema identifier and version information corresponding to the contents to be transmitted from now is notified to the data exchanger 21b.

The data exchanger 21b confirms presence of the schema data of a compatible version on the basis of the schema identifier. When the data exchanger 21b receives a response having such a schema, it may transmit only the contents data. When the data exchanger 21b receives a response having no such a schema, the transmit schema data may be transmitted along with the contents data. In the case of either one, the contents data and schema data are transmitted as text data having no hierarchical structure. Therefore, the data volume itself of the transmission data can be reduced.

The method of the present invention which is described in the embodiment of the present invention (refer to FIG. 12) can be stored as program executable by a computer in a recording medium such as a magnetic disc (flexible disk, a hard disk), an optical disc (compact disk-read only memory, DVD), and a semiconductor memory, and distributed on the market.

As discussed above, according to the present invention, generation of transmission data and transmission thereof can be effectively carried out with reducing data volume of transmission data when contents data stored in a database having a hierarchical structure is transmitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data exchanger apparatus comprising:
a first memory unit configured to store first data concerning a plurality of hierarchical structures, and second data concerning a plurality of attributes of a plurality of classification items that are configured with the hierarchical structures, respectively, with being associated in hierarchy therewith, each of the classification items having attributes including an attribute of an upper hierarchical classification item of the classification items;
a second memory unit configured to store a plurality of contents data belonging to the classification items, respectively, and containing attribute values of the attributes of the classification items;
a data generator to generate transmission data, the transmission data including text data, an identifier of each of the hierarchical structures and version information thereof, and the text data including the attribute values delimited by a first delimiter code and the contents data delimited by a second delimiter code; and
a data transmitter to transmit the transmission data.

2. The data exchanger apparatus according to claim 1, wherein the transmission data is a structured document, and includes the text data as a value of an element to configure the structured document.

3. The data exchanger apparatus according to claim 1, which includes another data generator to generate another transmission data including first text data concerning the classification items forming each of the hierarchical structures and a membership between the classification items of each of the hierarchical structure, and second text data concerning the attributes of the classification items, and another transmitter to transmit the another transmission data.

4. The data exchanger apparatus according to claim 3, wherein the another transmission data is a structured document, and includes each of the first text data and the second text data as a value of an element forming the structured document.

5. The data exchanger according to claim 3, wherein the another data generator generates the second transmission data when it receives a request for transmission of information on the hierarchical structure from the transmitter.

6. The data exchanger according to claim 1, wherein the data generator includes means for compressing the text data by a given compression scheme and generate the transmission data.

7. A data exchanger comprising:
a database to store contents data having a plurality of hierarchical structures associated in hierarchy with a plurality of classification items each having attributes including an attribute of an upper hierarchical classification item of the hierarchical classification items, the contents data configured with attribute values of the attributes of each of the classification items;
a receiver to receive transmission data including text data representing contents data to be registered with the database and an identifier and version information of one of the hierarchical structures containing the classification items registered with the contents data; and
a request unit configured to request information on the one of the hierarchical structures when the one of the hierarchical structures that corresponds to the identifier and the version information contained in the transmission fail to exist in the database.

8. A data exchanging method comprising:
preparing a database to store contents data having a plurality of hierarchical structures associated in hierarchy with a plurality of classification items each having attributes including an attribute of an upper hierarchical classification item of the classification items, the contents data configured with attribute values of the attributes of each of the classification items;
reading a plurality of contents data registered with the classification item of one hierarchical structure of the hierarchical structures;
generating transmission data including text data and an identifier and version information of each of the hierarchical structures, the text data including the attribute values delimited by a first delimiter code and the contents data delimited by a second delimiter code; and
transmitting the transmission data,

9. The method according to claim 8 wherein the transmission data has a structured document, and includes the text data as a value of an element forming the structured document.

10. The method according to claim 8, which includes generating another transmission data including first text data concerning the classification items forming each of the hierarchical structures and a membership between the classification items of each of the hierarchical structure, and second text data concerning the attributes of the classification items, and transmitting the another transmission data.

11. The method according to claim 10, wherein the another transmission data has a structured document, and includes each of the first text data and the second text data as a value of an element forming the structured document.

12. The method according to claim 10, which includes receiving a request for transmission of information on the one of the hierarchical structures, and generating the another transmission data includes generating the another transmission data when the request is received.

13. The method according to claim 8, wherein generating the transmission data includes compressing the text data by a given compression scheme to generate the transmission data.

14. The method according to claim 8, which includes receiving another transmission data containing text data expressing contents data to be registered with the database, and an identifier and version information of another hierarchical structure of the hierarchical structures including the classification item which the plurality of contents data are registered with, and requesting information on the another hierarchical structure when the another hierarchical structure corresponding to the identifier and the version information contained in the another transmission data fail to exist in the database.

15. A program stored in a computer readable medium for exchanging data comprising:
means for instructing a computer to store, in a database, contents data having a plurality of hierarchical structures associated in hierarchy with a plurality of classification items each having attributes including an attribute of an upper hierarchical classification item of the classification items, the contents data configured with attribute values of the attributes of each of the classification items;
means for instructing the computer to read a plurality of contents data registered with the classification item of one hierarchical structure of the hierarchical structures;
means for instructing the computer to generate transmission data including text data and an identifier and version information of each of the hierarchical structures, the text data including the attribute values delimited by a first delimiter code and the contents data delimited by a second delimiter code; and
means for instructing the computer to transmit the transmission data,

16. The program according to claim 15, which includes means for instructing the computer to generate another transmission data including first text data concerning the classification items forming each of the hierarchical structures and a membership between the classification items of each of the hierarchical structure, and second text data concerning the attributes of the classification items, and means for instructing the computer to transmit the another transmission data.

17. The program according to claim 15, which includes means for instructing the computer to receive another transmission data containing text data expressing contents data to be registered with the database, and an identifier and version information of another hierarchical structure of the hierarchical structures including the classification item which the plurality of contents data are registered with, and means for instructing the computer to request information on the another hierarchical structure when the another hierarchical structure corresponding to the identifier and the version information contained in the another transmission data fail to exist in the database.
